(19) United States
(12) Patent Application Publication
(10) Pub. No.: US 2013/0126436 A1
(43) Pub. Date: May 23, 2013

(54) STIRRING APPARATUS

(71) Applicants: Ji-tae OK, Changwon-city (KR); Seong-kook KIM, Changwon-city (KR)

(72) Inventors: Ji-tae OK, Changwon-city (KR); Seong-kook KIM, Changwon-city (KR)

(73) Assignee: SAMSUNG TECHWIN CO., LTD., Changwon-city (KR)

(21) Appl. No.: 13/307,742

(22) Filed: Nov. 30, 2011

(30) Foreign Application Priority Data
Nov. 18, 2011 (KR) 10-2011-0121192

(51) Int. Cl. B03C 1/30; B01F 13/08

(52) U.S. Cl. 210/695; 366/342

(57) ABSTRACT

A stirring apparatus and a method of separating magnetic beads from a sample including the magnetic beads are provided. The stirring apparatus includes at least one rotational body having a hollow formed therein; a driving unit which moves upward and downward and rotates the at least one rotational body; a cap which is combined with the rotational body, extends in a vertical direction, and has an internal space connected to the hollow of the rotational body; and a magnetic force application unit which moves upward and downward to be inserted into or taken out of the internal space of the cap via the hollow of the rotational body.

### CROSS-REFERENCE TO RELATED PATENT APPLICATION

This application claims priority from Korean Patent Application No. 10-2011-0121192, filed on Nov. 18, 2011 in the Korean Intellectual Property Office, the disclosure of which is incorporated herein in its entirety by reference.

### BACKGROUND

1. Field

Apparatuses and methods consistent with exemplary embodiments relate to stirring and mixing a liquid with another liquid, a solid, or powder, or separating magnetic beads from a sample including the magnetic beads.

2. Description of the Related Art

Currently, research is active in the biotechnology industry. In particular, research is actively conducted on technologies of extracting, transforming, and utilizing biological materials such as nucleic acid. The above research inevitably requires a method or apparatus for selectively extracting a certain target to be observed.

In the target extracting method or apparatus, technologies of increasing the efficiency of extraction and increasing the purity of an extracted material are very important. Accordingly, an apparatus for extracting a certain target from a fluid including a biological material is increasingly demanded.

The apparatus employs a method using beads or particles. Initially, a receptor corresponding to the target is coated on surfaces of the beads, and the coated beads are put into the fluid including the target. After that, the target contacts and is captured by the receptor coated on the surfaces of the beads. The above process is more activated if the number of times that the target contacts the beads increases. For this, a stirring apparatus may be used to allow the beads to move in the fluid by stirring the fluid or applying a variable magnetic field around the fluid. Accordingly, the beads may be magnetic beads that react to a magnetic force.

However, after the above process is performed, impurities as well as a target material may adhere to the beads. In order to prevent reduction in reliability of a test result, the impurities other than the target material need to be removed from an extracted material. The impurities may be removed by collecting the beads by using a magnet and then putting the beads into a cleaning fluid.

Further, in the above process, a plurality of beads may be stuck together and may be put into the cleaning fluid in a lump. In this case, the impurities which adhered onto the surfaces of the beads located outside the lump may be easily removed while the impurities adhered onto the surfaces of the beads located inside the lump may not be easily removed, which is not desirable. As such, the purity of the target extracted from the beads may be lowered.

In order to address this problem, the cleaning fluid may be stirred by using a stirring apparatus to separate the beads.

However, since a related art stirring apparatus generally dips a stirring tool into a sample and moves the stirring tool upward and downward in order to stir the sample, a stirring speed may be low and the sample may be scattered out of a test tube, thereby causing cross-contamination.

Accordingly, a new stirring apparatus capable of addressing the above problem is demanded.

### SUMMARY

One or more exemplary embodiments provide an efficient stirring apparatus.

According to an aspect of an exemplary embodiment, there is provided a stirring apparatus including at least one rotational body having a hollow formed therein; a driving unit which moves upward and downward and rotates the at least one rotational body; a cap which is combined with the rotational body, extends in a vertical direction, and has an internal space connected to the hollow of the rotational body; and a magnetic force application unit which moves upward and downward to be inserted into or taken out of the internal space of the cap via the hollow of the rotational body.

The cap may be detachably combined with the at least one rotational body. The magnetic force application unit may be a permanent magnet.

The driving unit may include at least one motor; and at least one gear which connects the at least one motor and the at least one rotational body directly or indirectly, respectively, to rotate the at least one rotational body. The at least one rotational body may include a plurality of rotational bodies, and the at least one gear comprises a plurality of gears which are gear-combined with one another to rotate the plurality of rotational bodies.

The driving unit may include at least one motor; a first pulley combined with the motor; at least one second pulley formed around the at least one rotational body, respectively; and at least one first belt which surrounds the first pulley and the least one second pulley to connect the at least one motor and the at least one rotational body to rotate the at least one rotational body. The at least one rotational body may include a plurality of rotational bodies, and the driving unit may further include a plurality of third pulleys which are formed around the plurality of rotational bodies; and at least one second belt which surrounds the third pulleys to rotate the plurality of rotational bodies. The stirring apparatus may further include a tension adjuster which adjusts tension of the at least one first and/or second belt. The plurality of rotational bodies may be aligned in at least two rows and columns, and the at least one second belt may pass through a space formed between neighboring rotational bodies of the plurality of rotational bodies in each row.

The at least one rotational body may include a main rotational body and at least one following rotational body, and the driving unit may include a rotational power unit which generates power; a first power transfer unit which transfers the power from the rotational power unit to the main rotational body; and a second power transfer unit which transfers the power from the main rotational body to the at least one following rotational body. Each of the first and second power transfer units may include at least one of a belt, a rack and pinion, a roller, a gear, and a chain.

According to an aspect of another exemplary embodiment, there is provided a method of separating magnetic beads, the method including dipping a rotational body combined with a cap into a container containing a liquid comprising the magnetic beads; stirring the liquid by rotating the rotational body; capturing the magnetic beads on the cap by inserting a magnetic force application unit into an internal space of the cap via a hollow formed in the rotational body; lifting the rotational body and the magnetic beads captured on the cap out of the container while the magnetic force application unit is being inserted into the internal space of the cap; and separating the magnetic beads from the cap by taking the magnetic force application unit out of the internal space of the cap.

The stirring the liquid may include stirring the liquid by moving upward and downward, and/or rotating the cap combined with the rotational body. The method may further include dipping the cap into another container containing another liquid after the rotational body is lifted. The magnetic force application means may be a permanent magnet.

### BRIEF DESCRIPTION OF THE DRAWINGS

The above and other aspects will become more apparent by describing in detail exemplary embodiments with reference to the attached drawings, in which:

FIG. 1 is a perspective view of a stirring apparatus according to an exemplary embodiment;

FIG. 2 is a cross-sectional view cut along a line II-II of the stirring apparatus illustrated in FIG. 1;

FIG. 3 is a cross-sectional view of an example of a portion of the stirring apparatus illustrated in FIG. 1;

FIGS. 4 through 6 are front views showing operation of the stirring apparatus illustrated in FIG. 1;

FIG. 7 is a cross-sectional view of another example of the portion of the stirring apparatus illustrated in FIG. 1;

FIG. 8 is a perspective view of a stirring apparatus according to another exemplary embodiment;

FIG. 9 is a cross-sectional view cut along a line IX-IX of the stirring apparatus illustrated in FIG. 8;

FIG. 10 is a perspective view of a stirring apparatus according to another exemplary embodiment;

FIG. 11 is a front view of the stirring apparatus illustrated in FIG. 10;

FIG. 12 is a left side view of the stirring apparatus illustrated in FIG. 10;

FIG. 13 is a cross-sectional view cut along a line A-A of the stirring apparatus illustrated in FIG. 10;

FIG. 14 is a perspective view of the stirring apparatus illustrated in FIG. 10 when a second support plate and second bearings are removed;

FIG. 15 is a plan view of the stirring apparatus illustrated in FIG. 14;

FIG. 16 is a magnified view of a portion B of the stirring apparatus illustrated in FIG. 15;

FIG. 17 illustrates a modified example of the portion B illustrated in FIG. 16;

FIG. 18 is a magnified view of a portion C of the stirring apparatus illustrated in FIG. 13; and

FIG. 19 is a bottom view of main rotational bodies of the stirring apparatus illustrated in FIG. 10.

### DETAILED DESCRIPTION OF THE EXEMPLARY EMBODIMENTS

Hereinafter, exemplary embodiments will be described in detail with reference to the attached drawings.

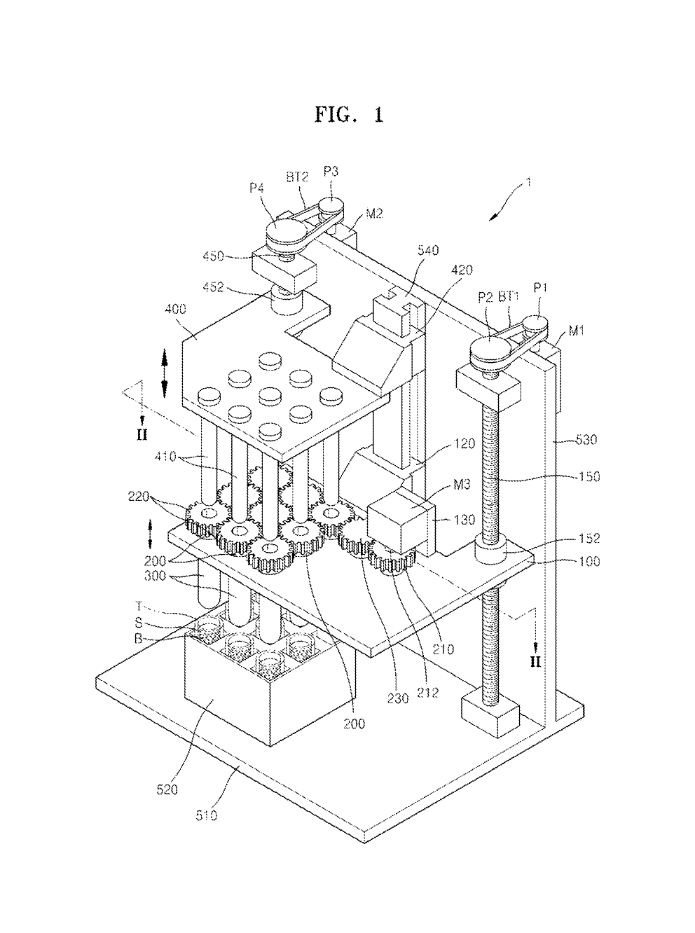

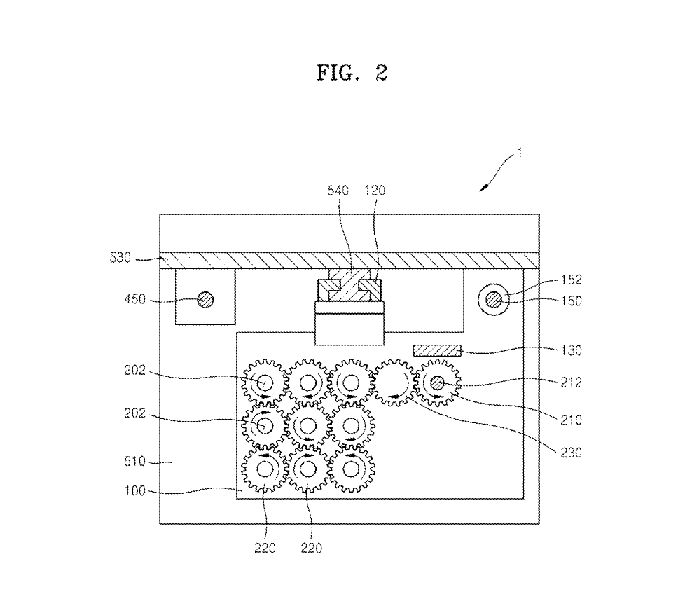

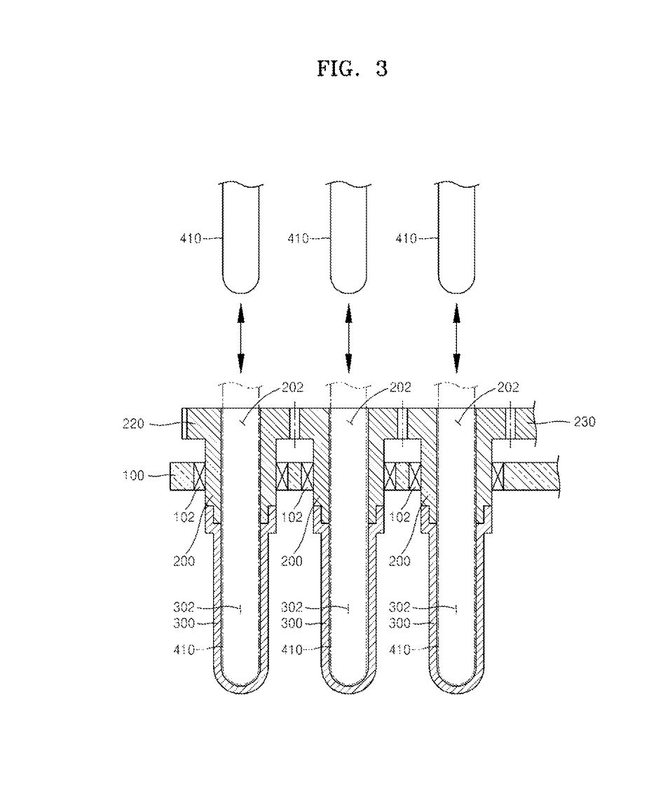

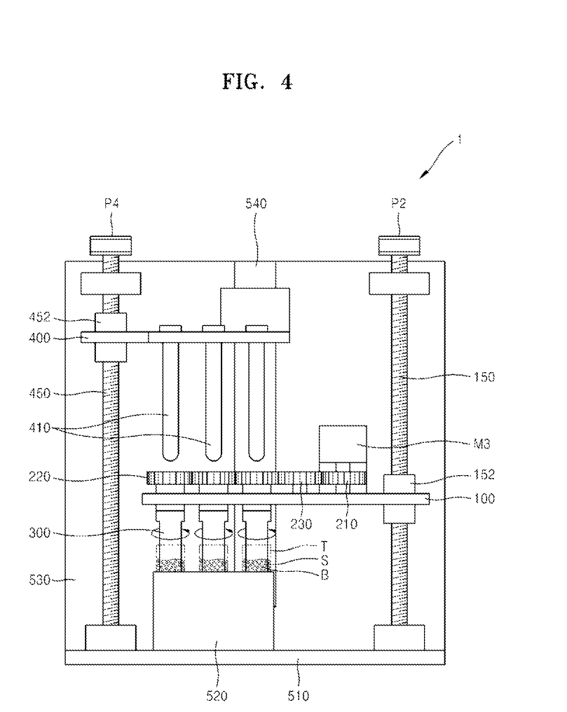

FIG. 1 is a perspective view of a stirring apparatus 1 according to an exemplary embodiment. FIG. 2 is a cross-sectional view cut along a line II-II of the stirring apparatus 1 illustrated in FIG. 1. FIG. 3 is a cross-sectional view of an example of a portion of the stirring apparatus 1 illustrated in FIG. 1. FIGS. 4 through 6 are front views showing operation of the stirring apparatus 1 illustrated in FIG. 1.

The stirring apparatus 1 according to the current exemplary embodiment is used to stir materials included in a sample S. The stirring apparatus 1 may also be used to capture magnetic beads B included in the sample S, in which case, the stirring apparatus 1 may be referred to as a magnetic beads separator. Furthermore, since the stirring apparatus 1 may be used in an overall process for capturing or extracting a biological material, for example, in lysis, stirring materials in the sample S and capturing the magnetic beads B required to detect a target biological material, the stirring apparatus 1 may also be referred to as a biomaterial extractor.

Referring to FIGS. 1 through 3, the stirring apparatus 1 includes a test tube holder 520, a lifting board 100, rotational bodies 200, caps 300, a magnetic force application unit, and a driving unit.

The test tube holder 520 is an element for holding a plurality of test tubes T containing the sample S, and is disposed on a lower plate 510. The test tube holder 520 may have a plurality of divided spaces for individually holding the test tubes T. The test tube holder 520 may be separable from the lower plate 510.

The lifting board 100 is disposed above the test tube holder 520, and is liftable upward or downward. The lifting board 100 includes a guide 120 and a ball nut 152 to be liftable upward or downward.

The guide 120 is fixed onto the lifting board 100, and is slidably combined with a guide rail 540 disposed in a vertical direction on a vertical plate 530 fixed onto the lower plate 510. Accordingly, a moving direction of the lifting board 100 is limited to a vertical direction.

The ball nut 152 is fixed to the lifting board 100, and is combined with a first ball screw 150 extending in a vertical direction. Accordingly, the lifting board 100 may be lifted upward or downward if the first ball screw 150 rotates.

The first ball screw 150 is rotatably disposed in parallel with the vertical plate 530, and a driven pulley P2 is disposed on a top portion of the first ball screw 150. Since the driven pulley P2 is connected by a belt BT1 to a driving pulley P1 combined with a rotation shaft of a motor M1, if the motor M1 rotates, the first ball screw 150 rotates, and thus, the lifting board 100 moves upward or downward.

The rotational bodies 200 are rotatably disposed on the lifting board 100 in such a way that their rotation axes extend in a vertical direction. Referring to FIG. 3, the rotational bodies 200 have hollows 202 extending to penetrate through the lifting board 100 in a vertical direction. As illustrated in FIG. 3, bearings 102 are disposed between the lifting board 100 and the rotational bodies 200 fitted into the lifting board 100 to allow the rotational bodies 200 to rotate. The bearings 102 may include thrust bearings.

The rotational bodies 200 are elements that rotate by the power transferred from the driving unit. Referring to FIGS. 3 through 5, although the rotational bodies 200 indirectly stir the sample S via the caps 300 combined with the rotational bodies 200 as will be described below, the inventive concept is not limited thereto, and the rotational bodies 200 may be directly dipped into and stir the sample S.

The driving unit includes a motor M3, a first gear 210, and a plurality of second gears 220.

The motor M3 is fixed onto a motor support 130 that is fixed onto the lifting board 100, and a rotation shaft 212 of the motor M3 extends in a vertical direction. The rotation shaft 212 of the motor M3 may rotate in two directions.

The first gear 210 is fixed to the rotation shaft 212 of the motor M3, and rotates if the motor M3 is driven.

The second gears 220 are formed individually around the rotational bodies 200, and one of the second gears 220 is gear-combined with the first gear 210. Referring to FIG. 2, the first and second gears 210 and 220 of the stirring apparatus 1 are gear-combined via a third gear 230. Alternatively, the first and second gears 210 and 220 may be directly gear-combined without using the third gear 230.

Referring to FIG. 2, the second gears 220 formed individually around the rotational bodies 200 are engaged with each other. Accordingly, if one second gear 220 rotates, the other second gears 220 also rotate and all of the rotational bodies 200 rotate together.

As such, if the motor M3 is driven, the rotational power of the first gear 210 is transferred to one of the second gears 220 and, since the second gears 220 are gear-combined with one another, all of the second gears 220 rotate. Consequently, if the motor M3 is driven, all of the rotational bodies 200 rotate.

As illustrated in FIG. 3, the caps 300 are fitted onto lower portions of the rotational bodies 200, and extend from the lifting board 100 toward the test tube holder 520. Although the caps 300 are fitted onto the rotational bodies 200, the caps 300 are detachable from the rotational bodies 200. The caps 300 may be formed of a synthetic resin through which a magnetic field passes. Referring to FIG. 3, the caps 300 have internal spaces 302 connected to the hollows 202 of the rotational bodies 200 and extending in a vertical direction.

The magnetic force application unit is an element having a magnetic force for drawing a magnetic material, and a plurality of magnets 410 are used as the magnetic force application unit in the current embodiment.

The magnets 410 are disposed above the lifting board 100, extend in a vertical direction, and individually correspond to the rotational bodies 200. The magnets 410 are fixed to and combined with a magnet support 400 that is liftable upward or downward, and are lifted upward or downward together with the magnet support 400. The magnets 410 may be permanent magnets for maintaining a magnetic force without electric power.

The magnet support 400 includes a guide 420 and a ball nut 452, and the guide 420 is slidably combined with the guide rail 540 to allow the magnet support 400 to move in a vertical direction. The ball nut 452 is combined with a second ball screw 450 to allow the magnet support 400 to move upward or downward if the second ball screw 450 rotates.

A driven pulley P4 is combined with a top portion of the second ball screw 450, and is connected by a belt BT2 to a driving pulley P3 combined with a motor M2. Accordingly, if the motor M2 is driven, the second ball screw 450 rotates and the magnets 410 are lifted.

When the magnets 410 are lowered in FIG. 3, the magnets 410 pass through the hollows 202 of the rotational bodies 200, and are inserted into the internal spaces 302 of the caps 300. When the magnets 410 are raised in FIG. 3, the magnets 410 get out of the internal spaces 302 of the caps 300 and the hollows 202 of the rotational bodies 200.

An operational method and effects of the stirring apparatus 1 will now be described. In the current embodiment, the stirring apparatus 1 is used to extract nucleic acid from cells by separating the magnetic beads B from the sample S including the magnetic beads B.

The magnetic beads B are added into the sample S including nucleic acid, and the sample S is put into the test tubes T. The test tubes T containing the sample S are held by the test tube holder 520, and the test tube holder 520 is put onto the lower plate 510.

If the test tube holder 520 is put onto the lower plate 510, the motor M1 for rotating the first ball screw 150 is driven to lower the lifting board 100. In this case, the magnets 410 are disposed above the lifting board 100 so as not to be inserted into the internal spaces 302 of the caps 300, as illustrated in FIG. 4.

If the lifting board 100 is lowered, the rotational bodies 200 and the caps 300 combined with the rotational bodies 200 are also lowered, and portions of the caps 300 are dipped into the sample S in the test tubes T, as illustrated in FIG. 4.

If the portions of the caps 300 are dipped into the sample S in the test tubes T, the motor M3 for rotating the first gear 210 is driven to rotate all of the rotational bodies 200. If the rotational bodies 200 rotate, the caps 300 also rotate, and thus, the sample S in the test tubes T rotates and is stirred. In this case, additionally, the lifting board 100 may move upward and downward in order to stir the sample S more efficiently.

In comparison to a related art stirring apparatus for stirring the sample S only by moving the caps 300 upward and downward without rotating the caps 300, the stirring apparatus 1 may greatly reduce a stirring time because the sample S is stirred by rotating the caps 300. Also, unlike the related art stirring apparatus, the stirring apparatus 1 may efficiently prevent the sample S from scattering out of the test tubes T while the caps 300 do not move upward and downward. Furthermore, although the related art stirring apparatus requires a large amount of driving power to move the caps 300 and the lifting board 100 upward and downward against inertia, the stirring apparatus 1 may consume a small amount of driving power because only the caps 300 rotate while the lifting board 100 stops. In addition, the stirring apparatus 1 may efficiently reduce vibration and noise in comparison to the related art stirring apparatus.

If the sample S is stirred, cells included in the sample S are destroyed and nucleic acid included in the cells spreads to be combined with the magnetic beads B.

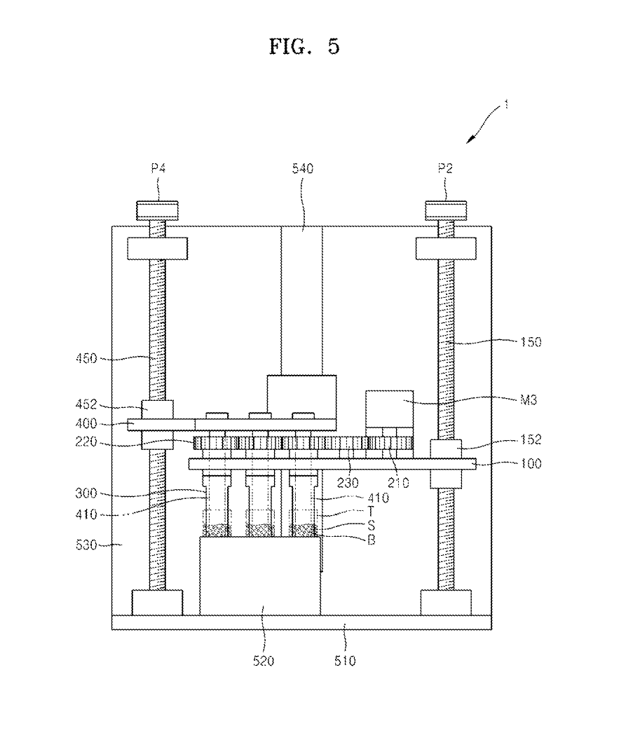

If the sample S is sufficiently stirred, and thus, nucleic acid is sufficiently combined with the magnetic beads B, the rotation of the rotational bodies 200 and the caps 300 is stopped by stopping the driving of the motor M3 for rotating the first gear 210. Then, the magnet support 400 and the magnets 410 are lowered, and the magnets 410 are inserted into the internal spaces 302 of the caps 300 by driving the motor M2 for rotating the second ball screw 450, as illustrated in FIG. 5.

If the magnets 410 are inserted into the internal spaces 302 of the caps 300, the magnetic beads B included in the sample S move toward the magnets 410 due to the magnetic force of the magnets 410. However, since the caps 300 are disposed around the magnets 410, the magnetic beads B adhere to outer surfaces of the caps 300.

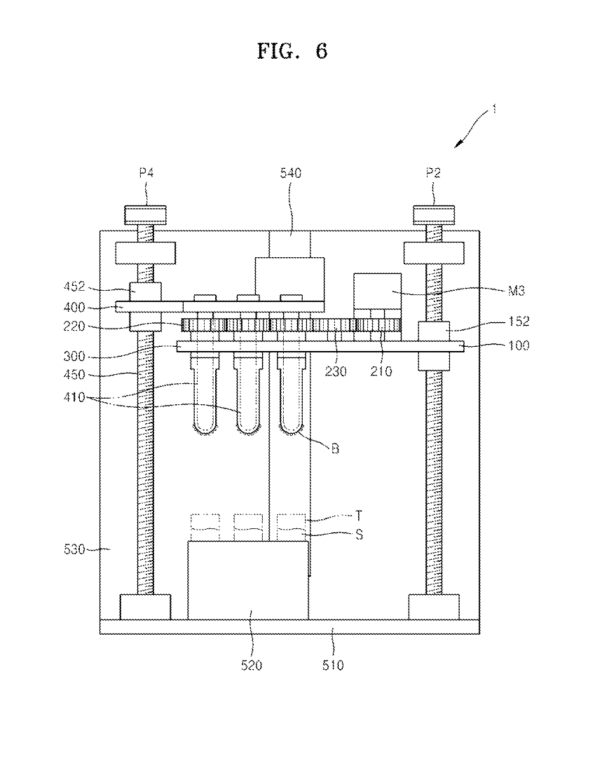

If the magnetic beads B adherer to the caps 300, the lifting board 100 and the magnet support 400 are raised upward by driving the motors M1 and M2 for respectively rotating the first and second ball screws 150 and 450 in a direction opposite to the direction in which the motors M1 and M2 are driven to lower the lifting board 100 and the magnet support 400. Accordingly, the magnetic beads B are raised while adhering to the caps 300, and thus, are separated from the sample S, as illustrated in FIG. 6.

Since the magnetic beads B are combined with nucleic acid included in the sample S, nucleic acid included in the sample S is extracted.

The magnetic beads B have to be put into a new container (not shown) to collect nucleic acid. For this, the caps 300 and the magnets 410 are inserted into the container, and only the magnets 410 are taken out of the internal spaces 302 of the caps 300 while leaving the caps 300 in the container. As such, the magnetic beads B are separated from the caps 300 and are collected in the container.

As described above, nucleic acid included in the sample S may be extracted from the sample S.

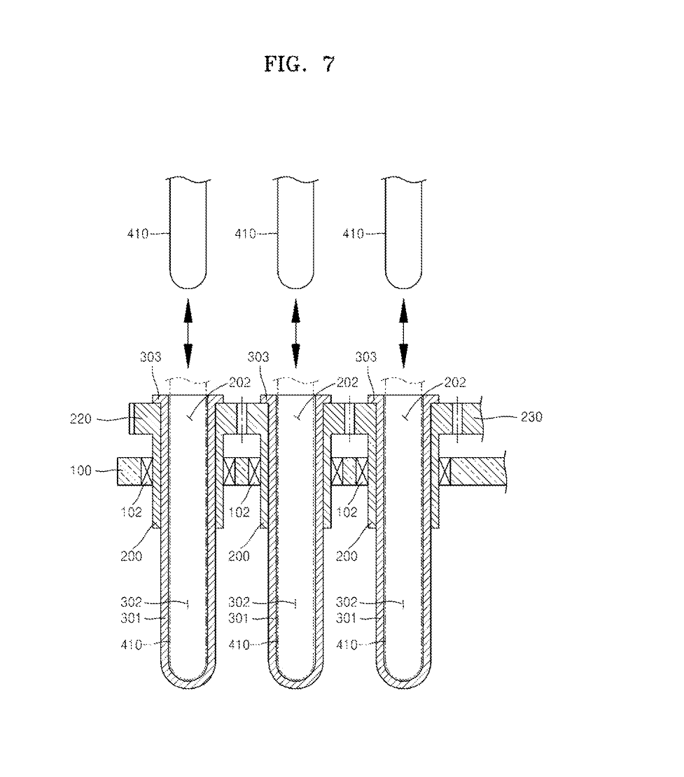

Meanwhile, although the caps 300 are combined with the lower portions of the rotational bodies 200 in the current embodiment, the inventive concept is not limited thereto, and may be implemented into another form. For example, as illustrated in FIG. 7, caps 301 may be inserted into the hollows 202 of the rotational bodies 200. Here, flanges 303 are formed on top portions of the caps, and prevent the caps 301 from slipping down through the hollows 202 of the rotational bodies 200. In this case, the internal spaces 302 of the caps 301 are also connected to the hollows 202.

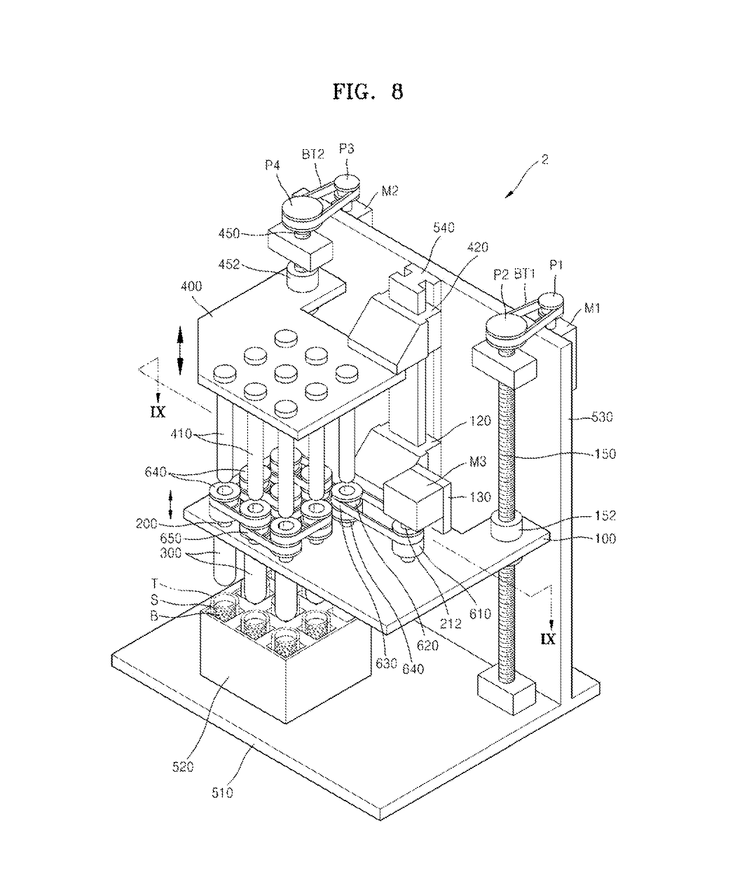

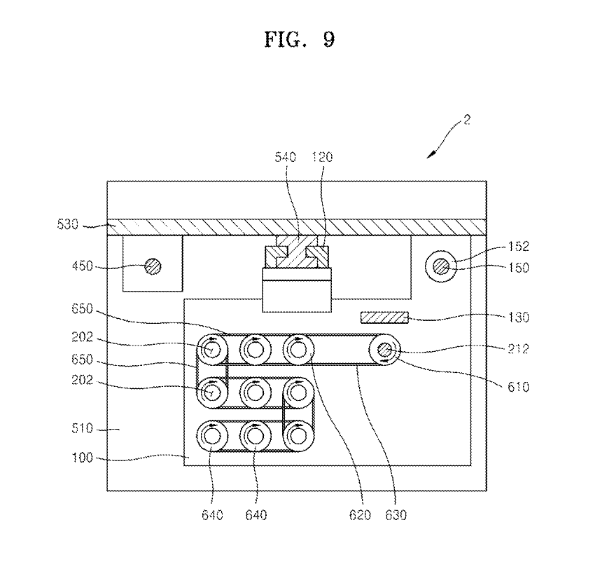

FIG. 8 is a perspective view of a stirring apparatus 2 according to another exemplary embodiment. FIG. 9 is a cross-sectional view cut along a line IX-IX of the stirring apparatus 2 illustrated in FIG. 8.

Referring to FIGS. 8 and 9, the stirring apparatus 2 according to the current embodiment also includes the test tube holder 520, the lifting board 100, the rotational bodies 200, the caps 300, the magnetic force application unit, and the driving unit.

The test tube holder 520, the lifting board 100, the rotational bodies 200, the caps 300, and the magnetic force application unit are the same as those of the stirring apparatus 1 illustrated in FIG. 1, and thus, detailed descriptions thereof are not provided here. Also, like reference numerals in FIGS. 1 and 2 denote like elements, and thus, detailed descriptions thereof are not provided here.

The driving unit of the stirring apparatus 2 includes the motor M3, a first pulley 610, a second pulley 620, a first belt 630, a plurality of third pulleys 640, and a plurality of second belts 650.

The motor M3 is fixed onto the motor support 130 that is fixed onto the lifting board 100.

The first pulley 610 is combined with the rotation shaft 212 of the motor M3 and rotates if the motor M3 is driven.

The second pulley 620 is formed around the rotational body 200 adjacent to the first pulley 610.

The first belt 630 surrounds the first and second pulleys 610 and 620, and transfers the rotational power of the first pulley 610 to the second pulley 620.

The third pulleys 640 are formed individually around the rotational bodies 200. The second pulley 620 and one third pulley 640 are respectively formed around upper and lower portions of the rotational body 200 adjacent to the first pulley 610, and two third pulleys 640 are formed around upper and lower portions of each of the other rotational bodies 200.

As illustrated in FIG. 9, each of the second belts 650 surrounds the third pulleys 640 of two neighboring rotational bodies 200 in such a way that all of the third pulleys 640 rotate together. That is, the second belts 650 individually connect neighboring third pulleys 640, and thus, sequentially connect all of the third pulleys 640. Accordingly, if the motor M3 is driven, the first pulley 610 rotates, the second pulley 620 connected to the first pulley 610 by the first belt 630 rotates, the third pulley 640 that surrounds the rotational body 200 together with the second pulley 620 rotates, and thus, all of the third pulleys 640 rotate because they are connected to each other by the second belts 650.

Consequently, if the motor M3 is driven, all of the rotational bodies 200 and the caps 300 rotate together.

In the current embodiment, in order to accurately transfer the rotational power of the motor M3, the first through third pulleys 610, 620, and 640 may be timing pulleys, and the first and second belts 630 and 650 may be timing belts.

Since elements of the stirring apparatus 2 other than the driving unit are the same as those of the stirring apparatus 1 illustrated in FIG. 1, an operational method and effects of the stirring apparatus 2 are similar to those of the stirring apparatus 1. However, the stirring apparatus 2 does not use gears to rotate the rotational bodies 200, and thus, does not have a gear jam.

Meanwhile, although the magnets 410 may be permanent magnets in the above embodiments, alternatively, the magnets 410 may be electromagnets.

Also, although the lifting board 100 is combined with the first ball screw 150, and the magnet support 400 is combined with the second ball screw 450 in the above embodiments, alternatively, the lifting board 100 and the magnet support 400 may be combined with one ball screw. In this case, the ball nut 452 may be rotatably disposed on the magnet support 400 such that the magnet support 400 may be lifted independently from the lifting board 100.

Furthermore, although the rotational bodies 200 are engaged with one another by gears or belts in the embodiments, alternatively, the rotational bodies 200 may be individually connected to a plurality of independent motors, and thus, may independently rotate.

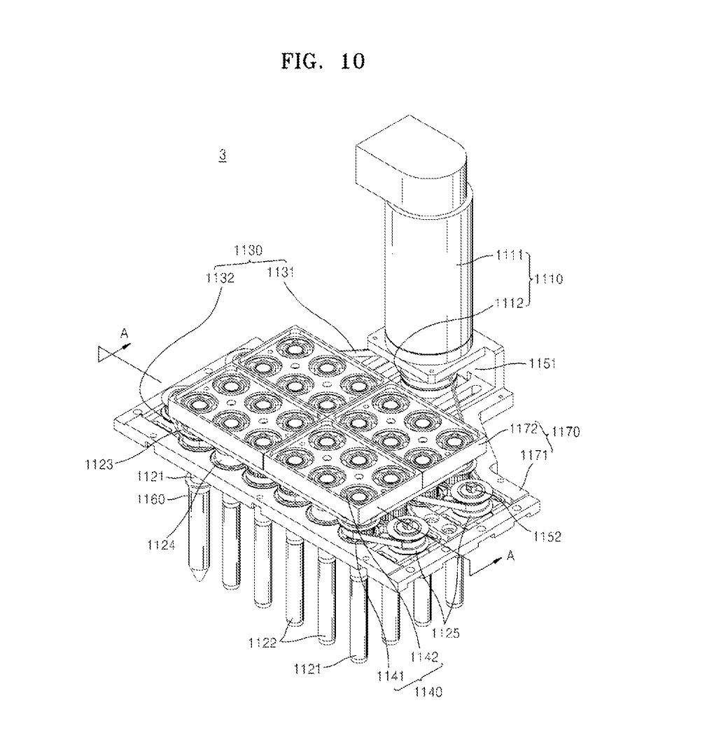

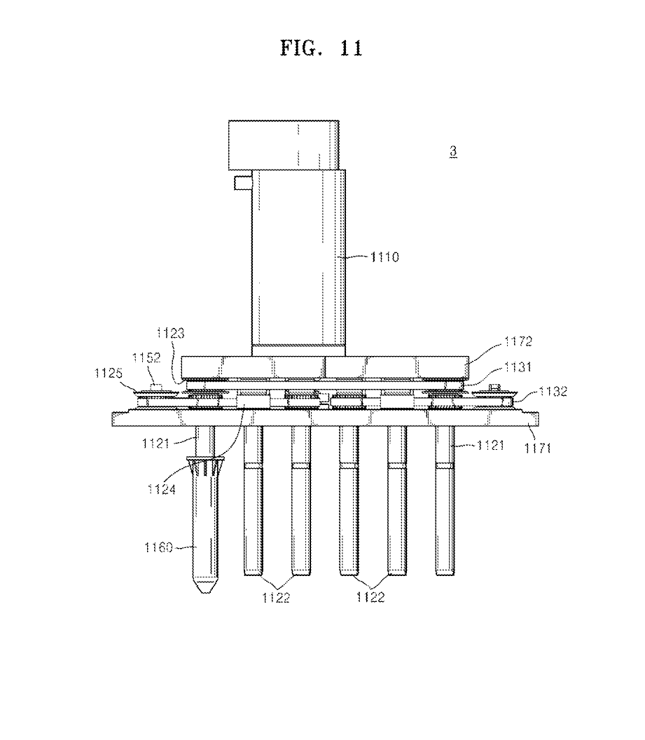

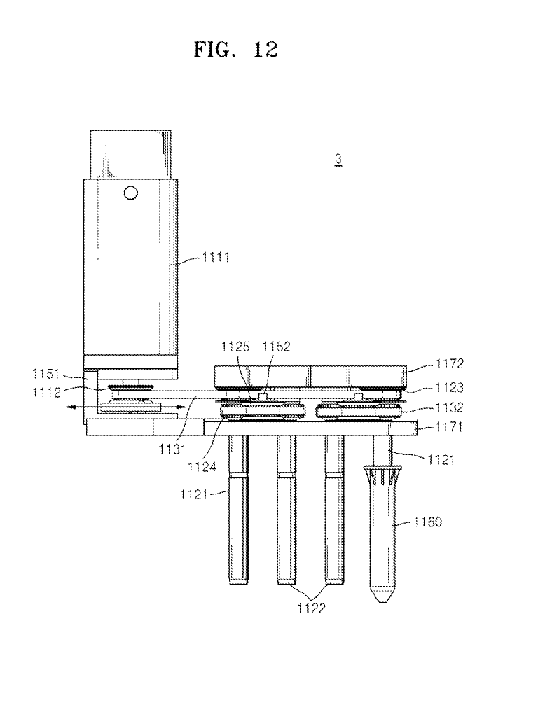

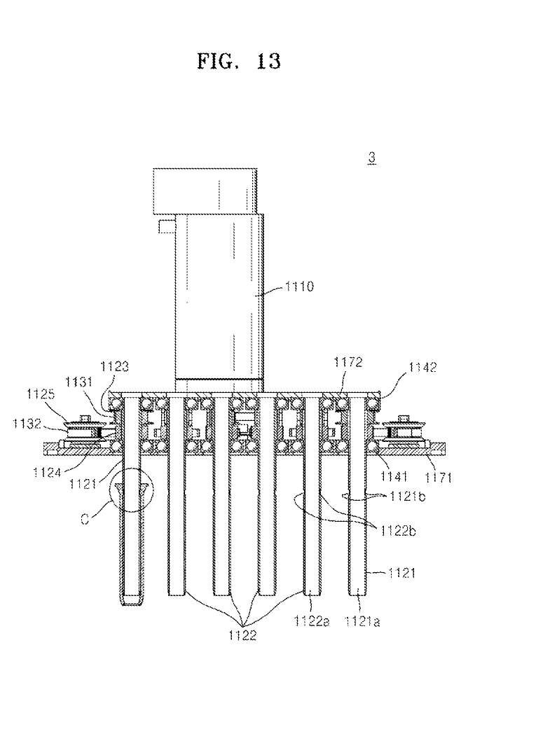

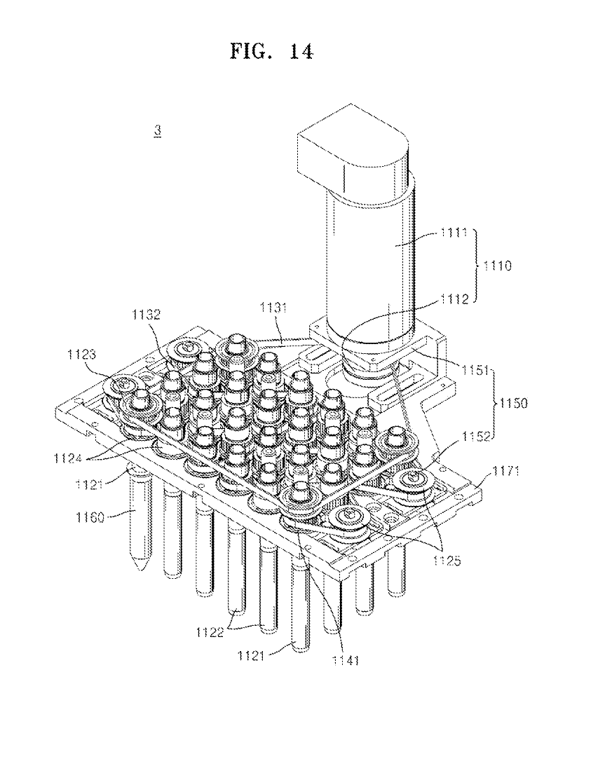

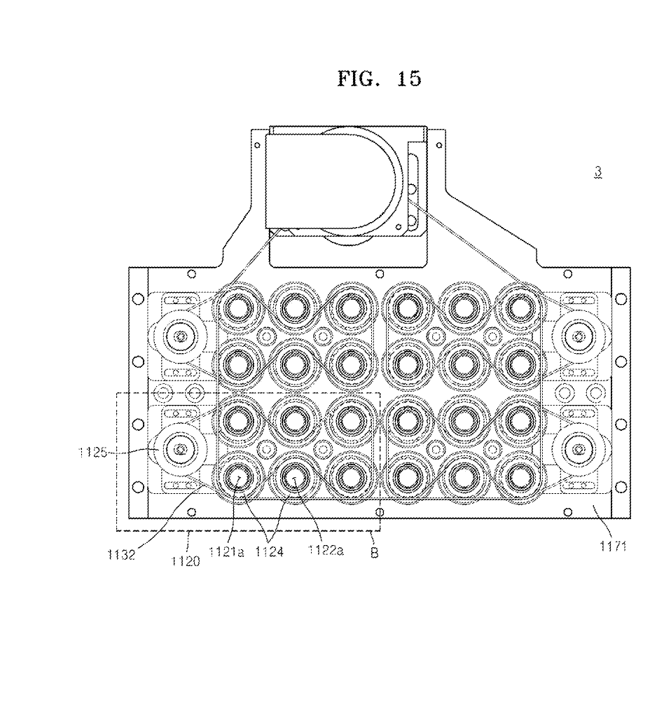

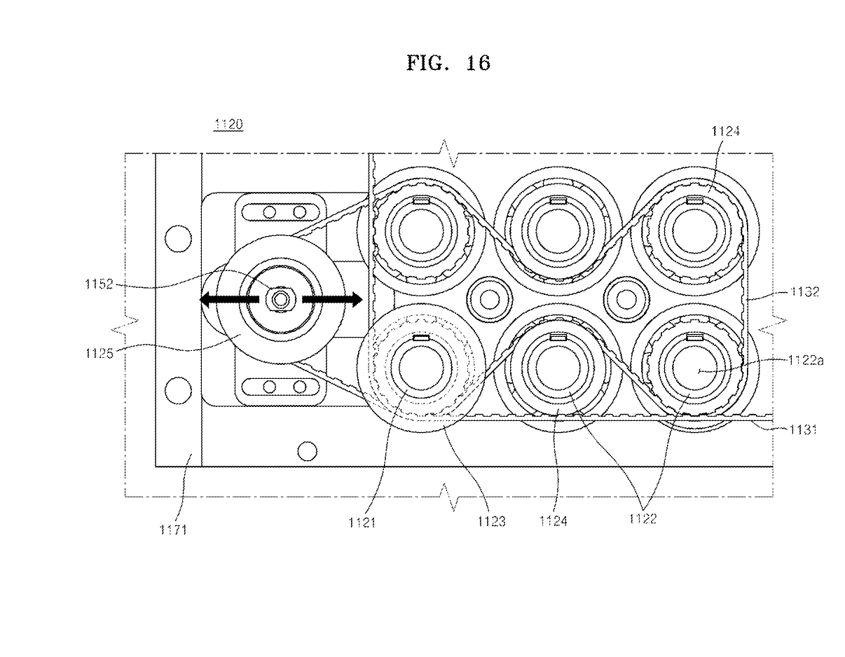

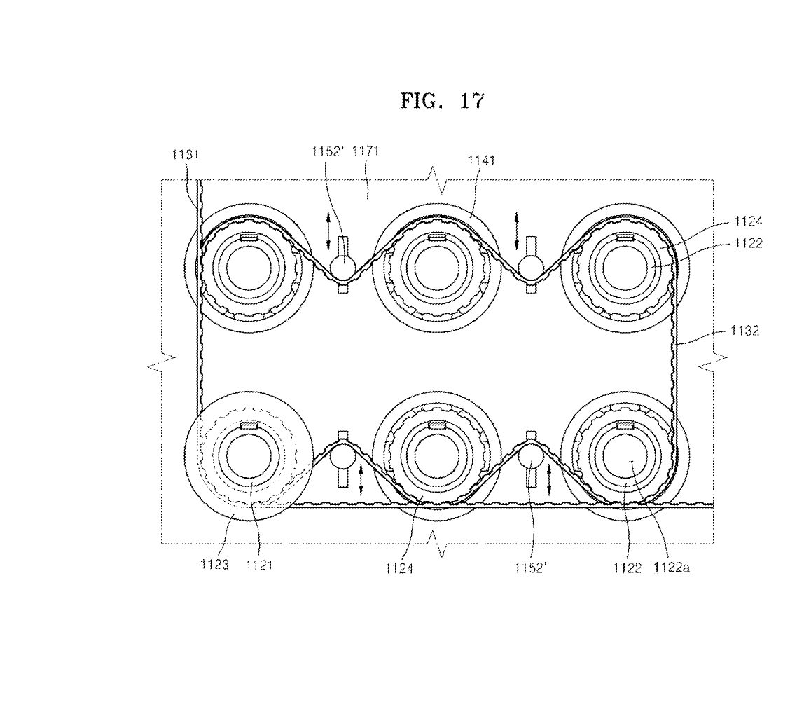

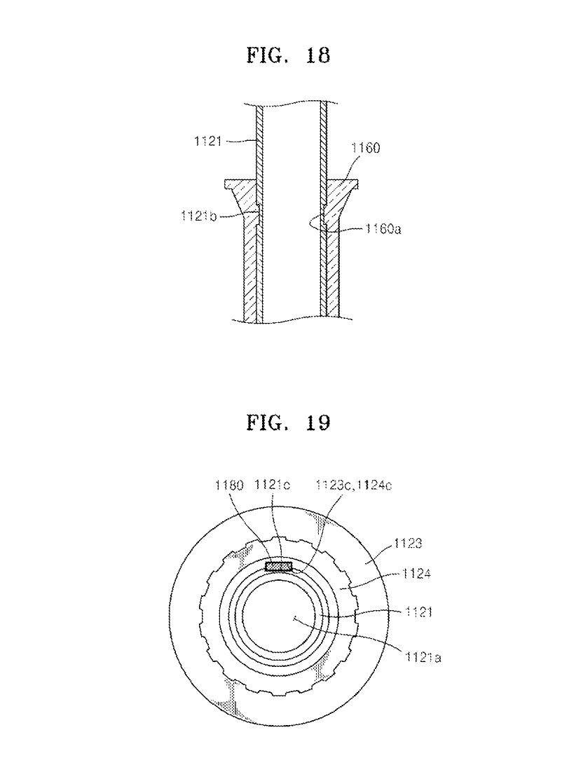

FIG. 10 is a perspective view of a stirring apparatus 3 according to another exemplary embodiment. FIGS. 11 and 12 are a front view and a left side view of the stirring apparatus 3 illustrated in FIG. 10. FIG. 13 is a cross-sectional view cut along a line A-A of the stirring apparatus 3 illustrated in FIG. 10. FIG. 14 is a perspective view of the stirring apparatus 3 illustrated in FIG. 10 when a second support plate 1172 and second bearings 1142 are removed. FIG. 15 is a plan view of the stirring apparatus 3 illustrated in FIG. 14. FIG. 16 is a magnified view of a portion B of the stirring apparatus 3 illustrated in FIG. 15. FIG. 17 illustrates a modified example of the portion B illustrated in FIG. 16. FIG. 18 is a magnified view of a portion C of the stirring apparatus 3 illustrated in FIG. 13. FIG. 19 is a bottom view of main rotational bodies 1121 of the stirring apparatus 3 illustrated in FIG. 10.

The stirring apparatus 3 illustrated in FIGS. 10 through 19 does not include the test tube holder 520, the lifting board 100, and the magnetic force application unit illustrated in FIGS. 1 through 9. However, in some cases, the above elements may be appropriately used in the stirring apparatus 3.

The stirring apparatus 3 is an apparatus for uniformly mixing materials included in a liquid or a solid contained in test tubes by putting and rotating rotational bodies into and in the test tubes. Accordingly, the stirring apparatus 3 may include rotatable rotational bodies and a driving unit for rotating the rotational bodies, and may further include bearings 1140 for smoothly rotating the rotational bodies, a tension adjuster 1150 for adjusting tension of belts 1130, caps 1160, and a support plate 1170.

Initially, the driving unit includes a rotational power unit 1110 for generating power required to rotate the main rotational bodies 1121 and following rotational bodies 1122, a first power transfer unit for transferring the power to the main rotational bodies 1121, and a second power transfer unit for transferring the power transferred to the main rotational bodies 1121 to the following rotational bodies 1122. In the current embodiment, the first and second power transfer units may respectively be a first belt 1131 and second belts 1132. However, the inventive concept is not limited thereto, and the first and second power transfer units may be implemented by belts, racks and pinions, rollers, gears, and/or chains. In this case, the first and second power transfer units may include different types of elements. For example, the first power transfer unit may include belts and the second power transfer unit may include rollers.

In the stirring apparatus 3, the rotational power unit 1110 generates rotational power for rotating the main and following rotational bodies 1121 and 1122, and includes a motor 1111 and a first pulley 1112. The motor 1111 is an element for generating rotational power, and includes a general electric motor for generating rotational power by using a magnetic field that varies according to supply of electricity. However, the rotational power unit 1110 is not limited thereto as long as rotational power to be transferred to the main and following rotational bodies 1121 and 1122 is generated. Also, the motor 1111 is not limited to the electric motor and may include various types of motors, e.g., an ultrasonic motor.

Furthermore, the motor 1111 may include a gearbox (not shown) for appropriately changing a rotational speed or torque of the motor 1111. Since rotational bodies need to rotate at a low or high speed in some cases, the gearbox receives power output from the motor 1111 having a single rotational speed and torque, and changes the output power to a rotational speed and torque desired by a user. Accordingly, the user may appropriately control the rotational bodies to have a required rotational speed by indirectly receiving the output power via the gearbox.

The power generated by the motor 1111 is transferred to the first pulley 1112 directly or indirectly via the gearbox. The first pulley 1112 rotates by the power. In this case, the first belt 1131 contacting a side surface of the first pulley 1112 moves according to the rotation of the first pulley 1112. Since the first belt 1131, as will be described below, transfers the power generated by the rotational power unit 1110 to rotational body sets 1120, a large amount of power is transferred by the first belt 1131, and thus, a strong frictional force may be applied between the first pulley 1112 and the first belt 1131. However, the inventive concept is not limited thereto.

Accordingly, in order to allow the first belt 1131 to transfer a larger amount of power, the first belt 1131 may be a timing belt having one surface on which a plurality of protrusions are formed at equal intervals, and teeth that rotate in engagement with the protrusions of the first belt 1131 may be correspondingly formed on the side surface of the first pulley 1112 contacting the surface of the first belt 1131 on which the protrusions are formed. Since the protrusions formed on the first belt 1131 and the teeth formed on the first pulley 1112 rotate in engagement with each other, slipping may not occur between the first belt 1131 and the first pulley 1112, and thus, a relatively stronger power may be transferred.

Also, in the present application, a pulley represents a belt pulley or a belt wheel, and is an element that rotates in contact with a belt. In addition to the first pulley 1112, the stirring apparatus 3 includes second pulleys 1123 and third pulleys 1124 which rotate respectively in contact with the first and second belts 1131 and 1132. Furthermore, similarly to the first pulley 1112, teeth that rotate in engagement with the protrusions of the first belt 1131 may be formed on side surfaces of the second pulleys 1123 which contact the first belt 1131. In addition, in order to appropriately transfer power between the third pulleys 1124 and the second belts 1132, similarly to the first belt 1131 and the first and second pulleys 1112 and 1123, a plurality of protrusions may be formed on one or two surfaces of each of the second belts 1132 at equal intervals, and teeth that rotate in engagement with the protrusions may be formed on side surfaces of the third pulleys 1124 which contact the second belts 1132.

As illustrated in FIG. 14, the power generated by the rotational power unit 1110 is transferred to the rotational body sets 1120 by the first belt 1131.

Referring to FIG. 10, the stirring apparatus 3 includes four rotational body sets 1120, and each rotational body set 1120 includes six rotational bodies in each of regions of the second support plate 1172 equally partitioned by protruding walls in vertical and horizontal directions. Also, the portion B represented by a dashed line in FIG. 15, or the portion illustrated in FIG. 16 or 17 represents one rotational body set 1120.

Although each rotational body set 1120 includes one main rotational body 1121 and five following rotational bodies 1122 in the current embodiment, the inventive concept is not limited thereto.

The main and following rotational bodies 1121 and 1122 are elements that rotate by the power transferred from the rotational power unit 1110, and portions of the main and following rotational bodies 1121 and 1122 are dipped into and rotate in a liquid to mix the liquid. Each of the main and following rotational bodies 1121 and 1122 has a shape of a cylinder extending in one direction, and rotates about the central axis of the cylinder. Hollows 1121a and 1122a are respectively formed through the main and following rotational bodies 1121 and 1122 in the extension direction, and bar-type magnets (not shown) may be inserted into the hollows 1121a and 1122a to collect magnetic beads included in the liquid.

The stirring apparatus 3 may be variously used to extract a target material from a biological sample, and may further include the caps 1160 to cover lower portions of the main and following rotational bodies 1121 and 1122 in order to prevent a resultant material from being contaminated. The caps 1160 may be detachable from the main and following rotational bodies 1121 and 1122 to be used only once or to be cleaned after used once. Referring to FIG. 18, in order to satisfy the above requirement, each of the caps 1160 has one closed end and one open end to accommodate the lower portions of the main and following rotational bodies 1121 and 1122, and protrusions 1160a protruding inward are formed around the open ends. Also, in correspondence with the protrusions 1160a, grooves 1121b and 1122b for partially accommodating the protrusions 1160a are formed in the lower portions of the main and following rotational bodies 1121 and 1122 so as to attach and detach the caps 1160. That is, the caps 1160 are relatively fixed onto the main and following rotational bodies 1121 and 1122 by allowing the protrusions 1160a formed on the caps 1160 to be partially accommodated in the grooves 1121b and 1122b formed in the main and following rotational bodies 1121 and 1122. However, the inventive concept is not limited to the above structure, and another structure in which the caps 1160 are detachable from the main and following rotational bodies 1121 and 1122 may also be used. Furthermore, the caps 1160 have internal spaces connected to the hollows 1121a and 1122a formed in the main and following rotational bodies 1121 and 1122, and are not limited to the above-described shape as long as the caps 1160 perform the above-described function.

In addition, when the magnetic beads are collected by inserting the magnets into the hollows 1121a and 1122a formed in the main and following rotational bodies 1121 and 1122, the caps 1160 may be formed of a material for not shielding magnetic fields of the magnets to allow the magnetic fields to influence the magnetic beads through the caps 1160. For example, the caps 1160 may be formed of a synthetic resin.

The main and following rotational bodies 1121 and 1122 pass through holes formed in a first support plate 1171 and the second support plate 1172. In this case, in order to reduce frictional forces between the first and second support plates 1171 and 1172, and the main and following rotational bodies 1121 and 1122, and to smoothly rotate the main and following rotational bodies 1121 and 1122, the bearings 1140 are formed on portions of the main and following rotational bodies 1121 and 1122 contacting the first and second support plates 1171 and 1172, and detailed descriptions thereof will be provided below.

The main rotational bodies 1121 are elements that rotate by the power transferred by the first belt 1131 from the rotational power unit 1110, and the following rotational bodies 1122 are elements that rotate by the power transferred by the second belts 1132 from the main rotational bodies 1121.

As described above, the main rotational bodies 1121 are elements for receiving power transferred by the first belt 1131, and transferring the power to the following rotational bodies 1122 via the second belts 1132. Accordingly, the second pulley 1123 that rotates in contact with the first belt 1131, and the third pulley 1124 that rotates in contact with the second belts 1132 are both formed around each of the main rotational bodies 1121.

Referring to FIGS. 11 and 12, all of the second and third pulleys 1123 and 1124 formed around the main rotational bodies 1121 are located between the first and second support plates 1171 and 1172. In particular, the second pulleys 1123 are formed around upper portions of the main rotational bodies 1121, and thus, are located relatively closer to the second support plate 1172, and the third pulleys 1124 are formed around lower portions of the main rotational bodies 1121, and thus, are located relatively closer to the first support plate 1171. All of the second and third pulleys 1123 and 1124 are attached to, and thus, rotate together with the main rotational bodies 1121. In this case, for more stable rotary motion, as illustrated in FIG. 19, rotational body grooves 1121c extending in a length direction of the main rotational bodies 1121 are formed in outer surfaces of the main rotational bodies 1121, and keys 1180, as rigid bodies, are partially accommodated in the rotational body grooves 1121c and pulley grooves 1123c and 1124c respectively formed in the second and third pulleys 1123 and 1124. The keys 1180 allow the main rotational bodies 1121 and the second and third pulleys 1123 and 1124 to rotate together and to resist against a stronger rotational power by locking them together.

The following rotational bodies 1122 are elements that rotate by the power transferred by the second belts 1132 from the main rotational bodies 1121, and the third pulleys 1124 that rotate in contact with the second belts 1132 are formed around the following rotational bodies 1122. Also, referring to FIG. 14, since additional pulleys are not formed around upper portions of the following rotational bodies 1122 corresponding to the upper portions of the main rotational bodies 1121 around which the second pulleys 1123 are formed, the following rotational bodies 1122 may not contact the first belt 1131. Furthermore, although not shown in FIGS. 10 through 19, the keys 1180 may also be applied to the following rotational bodies 1122. In this case, as in the main rotational bodies 1121, the keys 1180 may be partially accommodated in grooves (not shown) formed in the following rotational bodies 1122 and the third pulleys 1124, and may allow the following rotational bodies 1122 and the third pulleys 1124 to rotate together by locking relative motion between them.

An overall structure of the rotational body sets 1120 will now be described with reference to FIGS. 15 and 16. One rotational body set 1120 includes one main rotational body 1121 and five following rotational bodies 1122. A total of six rotational bodies are aligned in two rows and three columns, and the third pulleys 1124 and an idler pulley 1125 of each rotational body set 1120 are connected to each other by the second belt 1132. However, the inventive concept is not limited thereto as long as power is transferred to all rotational bodies. Also, the number of rotational bodies included in one rotational body set 1120 is not limited to six and may be variously changed.

Uniquely, the second belt 1132 passes through a space formed between two neighboring pulleys of one row in a zigzag pattern. As such, contact areas between the second belt 1132 and the third pulleys 1124 may be increased, and thus, power may be transferred more stably. Also, FIG. 17 illustrates a rotational body set 1120′ modified from the rotational body set 1120 illustrated in FIG. 16. Unlike the rotational body set 1120, in the rotational body set 1120′, the second belt 1132 does not pass between two neighboring pulleys in a zigzag pattern. However, contact areas between the second belt 1132 and the third pulleys 1124 may also be increased in this structure by using second tension adjusters 1152′ to be described below. Detailed descriptions thereof will be provided below.

Since power is transferred by belts, the power may not be properly transferred if the belts do not have appropriate tension. Accordingly, a stirring apparatus according to an exemplary embodiment includes a tension adjuster for adjusting tension of the belts.

The stirring apparatus 3 also includes a tension adjuster 1150 for adjusting tension of the first and second belts 1131 and 1132. The tension adjuster 1150 includes a first tension adjuster 1151 for adjusting tension of the first belt 1131, and second tension adjusters 1152 for adjusting tension of the second belts 1132.

The first tension adjuster 1151 is mounted on the rotational power unit 1110 and allows the rotational power unit 1110 to move in a direction toward or away from the rotational body sets 1120. That is, the first tension adjuster 1151 may move the rotational power unit 1110 in directions indicated by an arrow illustrated in FIG. 12. The tension of the first belt 1131 is increased if the rotational power unit 1110 moves in a direction away from the rotational body sets 1120, and is reduced if the rotational power unit 1110 moves in a direction toward the rotational body sets 1120. Accordingly, a position where the tension of the first belt 1131 is appropriate may be found while moving the rotational power unit 1110, and the rotational power unit 1110 may be fixed at the position to constantly apply an appropriate tension to the first belt 1131. However, the inventive concept is not limited thereto as long as the first tension adjuster 1151 may adjust the tension of the first belt 1131.

Also, each of the second tension adjusters 1152 is mounted on the idler pulley 1125 and allows the idler pulley 1125 to move in a direction toward or away from the main and following rotational bodies 1121 and 1122 of the rotational body set 1120. That is, the second tension adjuster 1152 may move the idler pulley 1125 in directions indicated by an arrow illustrated in FIG. 16. The tension of the second belt 1132 is increased if the idler pulley 1125 moves in a direction away from the main and following rotational bodies 1121 and 1122 of the rotational body set 1120, and is reduced if the idler pulley 1125 moves in a direction toward the main and following rotational bodies 1121 and 1122 of the rotational body set 1120. Accordingly, a position where the tension of the second belt 1132 is appropriate may be found while moving the idler pulley 1125, and the idler pulley 1125 may be fixed at the position to constantly apply an appropriate tension to the second belt 1132. However, the inventive concept is not limited thereto as long as the second tension adjuster 1152 may adjust the tension of the second belt 1132.

As described above, FIG. 17 illustrates the rotational body set 1120′ modified from the rotational body set 1120 illustrated in FIG. 16, and the rotational body set 1120′ includes six rotational bodies aligned in two rows and three columns, and the second tension adjusters 1152′. The second tension adjusters 1152′ are located between neighboring rotational bodies of each row, and adjust the tension of the second belt 1132. The second tension adjusters 1152′ may adjust the tension of the second belt 1132 and increase contact areas between the second belt 1132 and the third pulleys 1124 by partially moving the second belt 1132 to spaces between neighboring rotational bodies, thereby allowing appropriate rotary motion of the main and following rotational bodies 1121 and 1122. The second tension adjusters 1152′ may move in directions indicated by arrows illustrated in FIG. 17, and may rotate together with the second belt 1132. The tension of the second belt 1132 is increased if the second tension adjusters 1152′ move toward inside of the rotational body set 1120, and is reduced if the second tension adjusters 1152′ move toward outside of the rotational body set 1120. Accordingly, positions where the tension of the second belt 1132 is appropriate may be found while moving the second tension adjusters 1152′, and the second tension adjusters 1152′ may be fixed at the positions to constantly apply an appropriate tension to the second belt 1132.

The bearings 1140 are elements for smoothly rotating the main and following rotational bodies 1121 and 1122, and include first bearings 1141 and the second bearings 1142.

Referring to FIG. 13, the first bearings 1141 are inserted into holes formed in the first support plate 1171, and the main and following rotational bodies 1121 and 1122 penetrate through the holes in which the first bearings 1141 are formed. The first bearings 1141 have inner and outer surfaces respectively contacting the main and following rotational bodies 1121 and 1122 and the first support plate 1171, and thus, reduce shakes and frictions of the main and following rotational bodies 1121 and 1122 while they rotate. In this case, the first bearings 1141 may be ball bearings. However, the inventive concept is not limited thereto and various bearings including thrust bearings may be used.

The second bearings 1142 are inserted into holes formed in the second support plate 1172, and the main and following rotational bodies 1121 and 1122 penetrate through the holes in which the second bearings 1142 are formed. The second bearings 1142 have inner and outer surfaces respectively contacting the main and following rotational bodies 1121 and 1122 and the second support plate 1172, and thus, reduce shakes and frictions of the main and following rotational bodies 1121 and 1122 during rotation. In this case, the second bearings 1142 may be ball bearing. However, the inventive concept is not limited thereto and various bearings including thrust bearings may be used.

That is, since the second and first bearings 1142 and 1141 are respectively formed around upper portions of the second pulleys 1123 and lower portions of the third pulleys 1124 of the main rotational bodies 1121, and around upper and lower portions of the third pulleys 1124 of the following rotational bodies 1122, the main and following rotational bodies 1121 and 1122 may be guided to rotate and thus may smoothly rotate by greatly reducing shakes.

Operation of the stirring apparatus 3 will now be described.

Initially, tensions of the first and second belts 1131 and 1132 are appropriately adjusted by using the first and second tension adjusters 1151 and 1152. In order to adjust the tension of the first belt 1131, a position where the tension of the first belt 1131 is appropriate is found while moving the rotational power unit 1110, and the rotational power unit 1110 is fixed at the position. Likewise, in order to adjust the tensions of the second belts 1132, positions of the idler pulleys 1125 may be adjusted.

After the tensions of the first and second belts 1131 and 1132 are completely adjusted, the main and following rotational bodies 1121 and 1122 are partially dipped into a liquid, and then, the rotational power unit 1110 is driven. Power generated by the motor 1111 to which electricity is supplied is transferred to the first belt 1131 by the first pulley 1112. The first belt 1131 moves in contact with the second pulley 1123 of the main rotational body 1121 in each rotational body set 1120, and transfers the power to the second pulley 1123 to rotate the second pulley 1123. The second pulley 1123 rotates the main rotational body 1121 and the third pulley 1124 attached to the main rotational body 1121, and the rotational power of the third pulley 1124 is transferred by the second belt 1132 to the other third pulleys 1124 and the following rotational bodies 1122 in the rotational body set 1120 to rotate the following rotational bodies 1122. In this case, due to the alignment of the main and following rotational bodies 1121 and 1122 in the rotational body set 1120, and the second belt 1132, neighboring rotational bodies in each row rotate in different directions. The rotational power of the main and following rotational bodies 1121 and 1122 is transferred to the liquid to mix the liquid.

A stirring apparatus according to the present embodiment may greatly reduce operational noise by transferring rotational power via belts. As such, a user may not have an unpleasant feeling due to noise and the quality of products may be increased.

Also, since loads of a motor may be reduced in comparison to a related art stirring apparatus, an overall volume of the stirring apparatus according to the present embodiment may be reduced by employing a motor having a compact size and a small capacity.

Furthermore, if power is transferred via gears as in the related art stirring apparatus, heat may be generated due to friction between the gears, and thus, the temperature of the related art stirring apparatus may be increased. Here, the generated heat may be transferred to a sample stirred by the related art stirring apparatus and thus the sample may be modified. However, unlike the related art stirring apparatus, since the stirring apparatus according to the present embodiment employs belts, operational heat may be greatly reduced and thus the above problem may be solved.

As described above, according to the present exemplary embodiment, a sample may be efficiently stirred and thus a stirring speed of the sample may be greatly increased. Also, the sample may be efficiently prevented from scattering.

While the inventive concept has been particularly shown and described with reference to exemplary embodiments thereof, it will be understood by those of ordinary skill in the art that various changes in form and details may be made therein without departing from the spirit and scope as defined by the following claims.

What is claimed is:

1. A stirring apparatus comprising:
at least one rotational body having a hollow formed therein;
a driving unit which moves upward and downward and rotates the at least one rotational body;
a cap which is combined with the rotational body, extends in a vertical direction, and comprises an internal space connected to the hollow of the rotational body; and
a magnetic force application unit which moves upward and downward to be inserted into or taken out of the internal space of the cap via the hollow of the rotational body.

2. The stirring apparatus of claim 1, wherein the cap is detachably combined with the at least one rotational body.

3. The stirring apparatus of claim 1, wherein the magnetic force application unit comprises a permanent magnet.

4. The stirring apparatus of claim 1, wherein the driving unit comprises:
at least one motor; and
at least one gear which connects the at least one motor and the at least one rotational body directly or indirectly, respectively, to rotate the at least one rotational body.

5. The stirring apparatus of claim 4, wherein the at least one rotational body comprises a plurality of rotational bodies, and
wherein the at least one gear comprises a plurality of gears which are gear-combined with one another to rotate the plurality of rotational bodies.

6. The stirring apparatus of claim 1, wherein the driving unit comprises:
at least one motor;
a first pulley combined with the motor;
at least one second pulley formed around the at least one rotational body, respectively; and
at least one first belt which surrounds the first pulley and the least one second pulley to connect the at least one motor and the at least one rotational body to rotate the at least one rotational body.

7. The stirring apparatus of claim 6, wherein the at least one rotational body comprises a plurality of rotational bodies, and
wherein the driving unit further comprises:
a plurality of third pulleys which are formed around the plurality of rotational bodies; and
at least one second belt which surrounds the third pulleys to rotate the plurality of rotational bodies.

8. The stirring apparatus of claim 7, further comprising a tension adjuster which adjusts tension of the at least one first and/or second belt.

9. The stirring apparatus of claim 7, wherein the plurality of rotational bodies are aligned in at least two rows and columns, and
wherein the at least one second belt passes through a space formed between neighboring rotational bodies of the plurality of rotational bodies in each row.

10. The stirring apparatus of claim 6, wherein the at least one rotational body comprises a plurality of rotational bodies,
wherein the driving unit further comprises a plurality of third pulleys formed around the plurality of rotational bodies, and at least one second belt,
wherein the at least one second belt surrounds the at least one second pulley and the plurality of third pulleys to connect at least one of the plurality of rotational bodies and remaining rotational bodies of the plurality of rotational bodies to rotate the remaining rotational bodies.

11. The stirring apparatus of claim 1, wherein the at least one rotational body comprises a main rotational body and at least one following rotational body, and
wherein the driving unit comprises:
a rotational power unit which generates power;
a first power transfer unit which transfers the power from the rotational power unit to the main rotational body; and
a second power transfer unit which transfers the power from the main rotational body to the at least one following rotational body.

12. The stirring apparatus of claim 11, wherein each of the first and second power transfer units comprises at least one of a belt, a rack and pinion, a roller, a gear, and a chain.

13. A stirring apparatus comprising:
a plurality of rotational bodies each of which comprises one end open and another end closed, to form a hollow therein;
a driving unit which moves upward and downward and rotates the plurality of rotational bodies; and
a plurality of magnets which move upward and downward to be inserted into or taken out of the hollows of the plurality of rotational bodies, respectively.

14. The stirring apparatus of claim 13, wherein the driving unit rotates the plurality of rotational bodies by using at least one of a belt, a rack and pinion, a roller, a gear, and a chain.

15. The stirring apparatus of claim 13, wherein each of the rotational bodies is rotated by power transferred directly or indirectly thereto by at least one belt wound thereon and connecting the each of the rotational bodies and another of the rotational bodies or the driving unit.

16. The stirring apparatus of claim 13, wherein each of the plurality of rotational bodies comprises a rotational hollow and a cap which is detachably combined with the rotational hollow.

17. A method of separating magnetic beads, the method comprising:
dipping a rotational body combined with a cap into a container containing a liquid comprising the magnetic beads;
stirring the liquid by rotating the rotational body;
capturing the magnetic beads on the cap by inserting a magnetic force application unit into an internal space of the cap via a hollow formed in the rotational body;
lifting the rotational body and the magnetic beads captured on the cap out of the container while the magnetic force application unit is being inserted into the internal space of the cap; and
separating the magnetic beads from the cap by taking the magnetic force application unit out of the internal space of the cap.

18. The method of claim 17, wherein the stirring the liquid comprises stirring the liquid by moving upward and downward, and/or rotating the cap combined with the rotational body.

19. The method of claim 17, further comprising dipping the cap into another container containing another liquid after the rotational body is lifted.

20. The method of claim 17, wherein the magnetic force application unit is a permanent magnet.
